(19) United States
(12) Patent Application Publication
(10) Pub. No.: US 2009/0113301 A1
(43) Pub. Date: Apr. 30, 2009

(54) Multimedia Enhanced Browser Interface

(75) Inventors: Roberto Warren Fisher, Los Angeles, CA (US); Lucas Gonze, Venice, CA (US); Eglia Nair Flores, Santa Monica, CA (US); Lisa Fredrickson, Oakland, CA (US); Chris Kalaboukis, Los Gatos, CA (US); Ronald Martinez, San Francisco, CA (US); Ian C. Rogers, Santa Monica, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 11/925,365

(22) Filed: Oct. 26, 2007

(51) Int. Cl. G06F 3/048

(52) U.S. Cl. 715/716

(57) ABSTRACT

A toolbar application for network browser applications is described. The tool augments web pages with related multimedia content. The browser application allows the user to locate and render a web page of personal interest. The tool invokes a mechanism to identify one or more media objects related to the web page in a playlist, and invokes a media object player application to render the one or more media objects in the playlist. When all of the media objects in the playlist are complete, the enhancement application may automatically generate one or more additional playlists.

### TECHNICAL FIELD

The present disclosure relates generally to distribution of multimedia content over interactive networks, and particularly, to a mechanism for augmenting a network browser application to produce enhanced browser pages with related multimedia content.

### BACKGROUND

As means of communication improve, users of communication devices have an increased ability to consume and disseminate information, and to interact over the network through the sharing of information. This disclosure relates generally to improved means of interacting over the network by sharing media objects among interconnected users.

Modem communication networks are typically hierarchical transmission networks with multiple layers of transmission protocols. A transmission network is a system that allows two or more transceivers to exchange data, whereas a transmission protocol is a sequence of standard interactive steps that facilitate the exchange. Typically, the lowest level protocols are more concretely tied to the interaction of physical circuitry, whereas higher levels of protocols are more abstract to facilitate higher level processing at an algorithmic level. For example, in the vernacular “the web,” also known as “the Internet,” has become shorthand for a multi-layer computer communications system, which combines higher level protocols for access, mid-level protocols, such as a means of locating resources available on the network through a system of uniform resource locaters (URLs), and low-level hardware protocols which control the exchange of large, uneven blocks of data by breaking them into smaller, standardized packets. Users seek improved means to gather, transfer, and share multimedia information with other users, without the burden of managing lower-level protocols or learning new programming languages.

The network user perceives information conveyed through various forms of media objects, including text, icons, voice, audio recordings, pictures, or videos. Descriptions of one or more forms of media objects may be combined in a data object, which the consumer accesses over the network. The data object may contain additional “metadata” information which is not typically observed by the consumer, but may instead define parameters useful in conveying information to the consumer, such as user identifiers, data locaters, date types, or data interpretation resources, as described below. Metadata may combine one or more specialized categories of metadata, such as a “meta identifier”, a “meta keyword”, and so on.

Users communicating over a network typically use a physical device, such as a telephone, a text messenger, a cell phone, a personal digital assistant (PDA), a networked music/video player, a personal computer, or a public terminal, to interconnect with other users on the network. The shared information may be conveyed through various forms of media, including text, voice and audio recordings, pictures, animations and movie videos. Network users are able to perform social functions which are analogous to their real world counter-parts, such as to send and receive mail, to chat interactively, or to publish original works or compositions of other works, all in electronic forms over the network. A network user utilizes a number of application programs to create or consume content on the network. Example application programs typically include an “e-mail client,” a “chat client,” a “media object player,” and a “browser”.

A browser is an application program that is generally intended to display “web pages.” A web page is typically a two-dimensional image appearing as an individual page of information including one or more types of contained media. Multimedia content on the network appears in a virtual book format, which typically is displayed as an individually framed “web page” along with means for navigating to other related web pages. A web page is typically a two-dimensional image appearing as an individual page of information including one or more types of associated media objects. A web page may also be associated with consumer perceived audio output. Data for web pages is often described in a format known as a Document Object Model (DOM).

The multimedia content may be directly perceived on the web page or may be indirectly accessible. Content on the page may be directly perceived by including displayed images, videos, or a media object player rendered within the image of the page. Examples of indirect access include access to an audio recording through background music, access through an auxiliary page or pop-up window, access through an auxiliary program such as Microsoft's Windows Media Player®, or access provided through a link to another page. Many web pages incorporate one or more “hot links.” The hot link enables a consumer to access another web page or another application by pointing to and clicking on the hot link using a computer input pointing device such as a mouse. Consumers typically have the ability to reject the web page or additional media offering(s) through controls in the browser user interface, such as by clicking on a “close box” using the mouse to remove or “close” a displayed window image.

A network user may also become a composer to create new web pages. The DOM for a web page is typically stored in a data file using a common programming language, such as Hyper Text Markup Language (HTML). The composer may compose the web page directly by creating a description in the common programming language, or may compose the web page indirectly using an application program to combine text descriptions and other media into a page description in HTML or another suitable language. A composer may further combine one or more web pages to create a “website.” A website may be self-contained, in that it consists solely of web pages created for that site and a means for navigating among the contained web pages. More commonly, a website contains a combination of composer-generated content as well as links to other content or applications on the web. Typically, the composer may review a new web page or website composition on his computer using his browser the composer may also disseminate the new web page or website to other users on the network by publishing his page description(s) on a “web server”, where a web server is a server connected to the communications network that will provide published web pages in response to requests from authorized users on the network.

A browser may also support one or more plug-ins. A plug-in operates within the context of an existing web browser. The plug-in is operative to functionally replace, augment, or modify the functionality of the browser, to enable one or more program steps to be performed in the browser environment. Plug-ins may also represent an alternative way for a consumer to access a stand-alone software application. For example, Yahoo! Instant Messenger© is available as a stand-alone client application program that allows two or more networked users to chat interactively over the network. The Instant Messenger client application is also available as a plug-in to run in a browser window.

A browser may also include a toolbar application menu, such as Yahoo! Toolbar ©. The toolbar application menu typically displays one or more application icons near the top of the browser window. To access a toolbar application, a browser user typically uses the pointing device to point to the application icon. On a personal computer with a two-button mouse, the left button is engaged to start the toolbar application, whereas the right button is often engaged to adjust toolbar application preferences.

The toolbar application interface is typically displayed in or near the currently displayed window page, in a pop-up window, in a side-bar window or “drawer,” or in a tabbed window. A sidebar window or “drawer” is a rectangular screen area typically attached to the side or bottom of a browser window display. Some sidebar windows have interface controls to hide, show, or resize the side-window, opening or closing it like a drawer. The sidebar window typically displays a user interface for a sidebar application program.

A tabbed window is typically a rectangular screen area suggestive of a stack of manila folders. Each current page has a labeled tab, and only the page on top of the stack is visible. The user may navigate among the current pages by clicking on one of the tabs, to make it appear as though the corresponding window had been moved to the top of the stack.

As mentioned previously, a consumer may use an auxiliary program to perceive media objects, such as the Windows Media Player®, available from Microsoft Corporation of Redmond, Wash., the RealPlayer® from RealNetworks, Inc. of Seattle, Wash., or the QuickTime® player from Apple Computer Inc. of Cupertino, Calif. Each of these players is able to process a variety of data file formats describing media objects. Example data file formats include JPEG, TIFF, or PIC format data files for photographs, WAV, MP3, or AIFF format data files for audio recordings, and AVI, MPEG, or H.264 format data files for video recordings. The consumer typically locates and accesses a media object described in a suitable format for his or her auxiliary program. If the media object is not directly available in a suitable format, the consumer may convert the media object file formate to a suitable format using conversion software, such as Harmony Technology® from RealNetworks, Inc.

When the media object is a recording, the typical media object player has a user control interface akin to that of a tape recorder, with user controls to play, pause, fast forward,

Browser users typically spend a lot of time to navigate the network to search for and access digital media objects. There is a need to provide more convenient means of locate, access, and render digital media object related to the personal interests of users.

### SUMMARY

A real-time multimedia enhancer for network browser applications is described. Browser users access the services of a software provider to download a plug-in enhancement application optionally displayed as a browser toolbar application. The browser application allows the user to locate and render a web page of personal interest. The enhancement application provides an enhancement mechanism to identify one or more media objects related to the web page in a playlist, and invokes a media object player application to render the one or more media objects in the playlist. When all of the media objects in the playlist are complete, the enhancement application may automatically generate one or more additional playlists.

### BRIEF DESCRIPTION OF THE DRAWINGS

FIG. 1 is an example computer system architecture.

FIG. 2 illustrates an example network environment.

FIG. 3 illustrates an example client-server for service registration.

FIG. 4 is a flowchart for an example service registration process.

FIG. 5 illustrates a browser window with an example toolbar menu.

FIG. 6 illustrates an example playlist player.

FIG. 7 illustrates an example browser window including a player interface.

FIG. 8 illustrates a user obtaining playlists and media objects.

FIG. 9 is a flowchart for an example playlist generating process.

FIG. 10 is an example pop-up player interface.

FIG. 11 is an alternative browser window and player interface.

### DETAILED DESCRIPTION

The following embodiments and aspects thereof are described and illustrated in conjunction with systems, apparatuses and methods meant to be exemplary and illustrative, not limiting in scope. In various embodiments, one or more of the above-described problems have been reduced or eliminated.

The following description sets forth numerous details to provide a thorough understanding of various aspects of the present invention. It will be apparent to those skilled in the art, however, that the present invention may be practiced without these specific details. In other instances, algorithms for processing data and symbolic representations of algorithmic operations are the means used by those skilled in the art to most effectively convey the substance of their work to others skilled in the art. An algorithm, as used herein, is a sequence of operations leading to a desired result, said operations requiring physical manipulations of physical quantities. Usually, though not necessarily, these quantities take the form of a sequence of electrical signals representing binary numbers to be stored, transferred, combined, compared, and otherwise manipulated.

The present invention also relates to apparatus for performing the operations herein. This apparatus may be specially constructed for the required purposes, or it may comprise one or more general-purpose computers selectively activated by one or more computer programs to achieve the required results. Such a computer program may be stored in any suitable computer-readable storage medium. A computer-readable storage medium includes any mechanism for storing or transmitting information in a form that is usable by a machine, such as a general-purpose computer.

The algorithms and displays presented herein are not inherently related to any particular computer or other apparatus. Various general-purpose systems may be used in accordance with the teachings herein, and it may prove expedient to construct more specialized apparatus to perform the algorithm operations. The required structure for a variety of these systems may appear from the description below. In addition, the present invention is not described with reference to any particular programming language. Those skilled in the art will appreciate that a variety of programming languages may be used to implement the teachings of the invention as described herein.

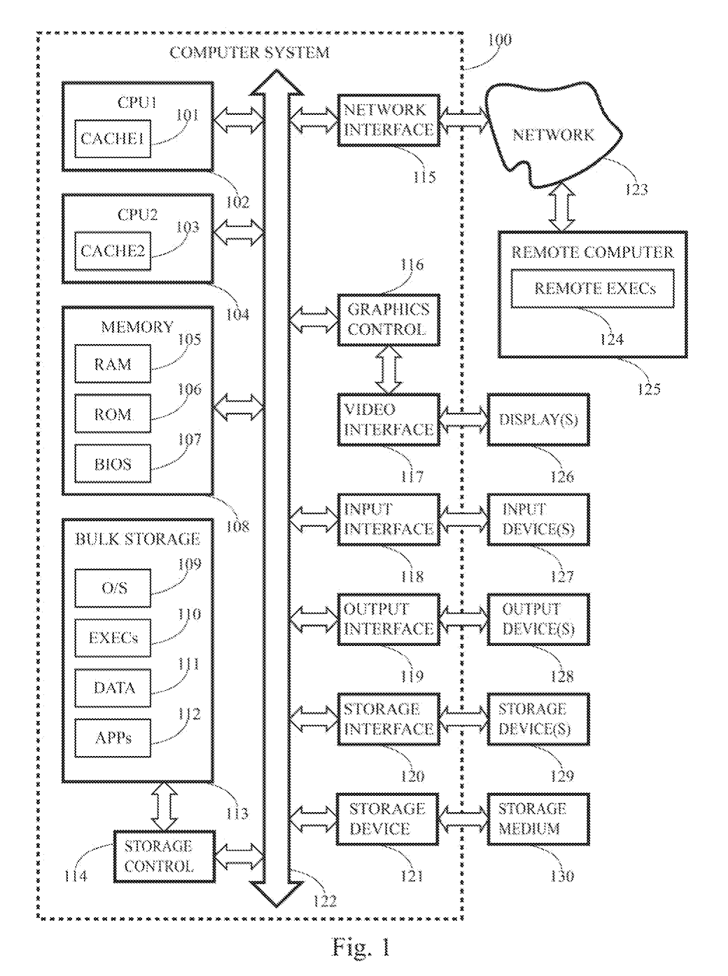

Server and client systems described herein can be implemented by a variety of computer systems and architectures. FIG. 1 illustrates suitable components in an exemplary embodiment of a general-purpose computer system. The exemplary embodiment is only one example of suitable components and is not intended to suggest any limitation as to the scope of use or functionality of the invention. Neither should the configuration of components be interpreted as having any dependency or requirement relating to any one or combination of components illustrated in the exemplary embodiment of a computer system. The invention may be operational with numerous other general purpose or special purpose computer system environments or configurations.

The invention may be described in the general context of computer-executable instructions, such as program modules, being executed by a computer. Generally, program modules include routines, programs, objects, components, data, structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 1, an exemplary system for implementing the invention may include a general-purpose computer system 100. Computer system 100 accesses one or more applications and peripheral drivers directed to a number of functions described herein. Components of the computer system 100 may include, but are not limited to, a CPU or central processing unit 102, a system memory 108, and a system bus 122 that couples various system components including the system memory 108 to the processing unit 102. As used by those skilled in the art, a signal “bus” refers to a plurality of digital signal lines serving a common function. The system bus 122 may be any of several types of bus structures including a memory bus, a peripheral bus, and a local bus using any of a variety of bus architectures. By way of example, and not limitation, such architectures include the Industry Standard Architecture (ISA) bus. Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

An operating system manages the operation of computer system 100, including the input and output of data to and from applications (not shown). The operating system provides an interface between the applications being executed on the system and the components of the system. According to one embodiment of the present invention, the operating system is a Windows® 95/98/NT/XP/Vista/Mobile operating system, available from Microsoft Corporation of Redmond, Wash. However, the present invention may be used with other suitable operating systems, such as an OS-X® operating system, available from Apple Computer Inc. of Cupertino, Calif, a UNIX® operating system, or a LINUX operating system.

The computer system 100 may include a variety of computer-readable media. Computer-readable media can be any available media that can be accessed by the computer system 100 and includes both volatile and nonvolatile media. For example, computer-readable media may include volatile and nonvolatile computer storage media implemented in any method or technology for storage of information such as computer-readable instructions, data structures, program modules or other data. Computer storage media includes, but is not limited to, random access memory (RAM), read-only memory (ROM), electrically erasable programmable ROM (EEPROM), flash memory or other memory technology, compact-disk ROM (CD-ROM), digital versatile disks (DVD) or other optical disk storage, magnetic tape cassettes, magnetic tape, hard magnetic disk storage or other magnetic storage devices, floppy disk storage devices, magnetic diskettes, or any other medium which can be used to store the desired information and which can accessed by the computer system 100.

Communication media may also embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. For instance, communication media includes wired media such as a wired network or direct-wired connection, and wireless media such as acoustic, RF, infrared, cellular networks, and other wireless media.

The system memory 108 includes computer storage media in the form of volatile and/or nonvolatile memory such as read only memory (ROM) 106 and random access memory (RAM) 105. A basic input/output system 107 (BIOS), containing the basic routines that help to transfer information between elements within computer system 100, such as during start-up, is typically stored in ROM 106 and other non-volatile storage, such as Hash memory. Additionally, system memory 108 may contain some or all of the operating system 109, the application programs 112, other executable code 110 and program data 111. Memory 108 typically contains data and/or program modules that are immediately accessible to and/or presently being operated on by CPU 102. Optionally, a CPU may contain a cache memory unit 101 for temporary local storage of instructions, data, or computer addresses.

The computer system 100 may also include other removable/non-removable, volatile/nonvolatile computer storage media. By way of example only, FIG. 1 illustrates a bulk storage 113 that reads from or writes to one or more magnetic disk drives of non-removable, nonvolatile magnetic media, and storage device 121 that may be an optical disk drive or a magnetic disk drive that reads from or writes to a removable, a nonvolatile storage medium 130 such as an optical disk or a magnetic disk. Other removable/non-removable, volatile/nonvolatile computer storage media that can be used in the exemplary computer system 100 include, but are not limited to, magnetic tape cassettes, flash memory cards, digital versatile disks, digital video tape, solid state RAM, solid state ROM, and the like. Bulk storage 113 and the storage device 121 may be connected directly to the system bus 122, or alternatively may be connected through an interface such as storage controller 114 shown for bulk storage 113. Storage devices may interface to computer system 100 through a general computer bus such as 122, or may interconnect with a storage controller over a storage-optimized bus, such as the Small Computer System interface (SCSI) bus, the ANSI ATA/ATAPI bus, the Ultra ATA bus, the FireWire (IEEE 1394) bus, or the Serial ATA (SATA) bus.

The storage devices and their associated computer storage media, discussed above and illustrated in FIG. 1, provide storage of computer-readable instructions, executable code, data structures, program modules and other data for the computer system 100. In FIG. 1, for example, bulk storage 113 is illustrated as storing operation system 109, application programs 112, other executable code 110 and program date 111. As mentioned previously, data and computer instructions in 113 may be transferred to a system memory 108 to facilitate immediate CPU access from processor 102. Alternatively, processor 102 may access stored instructions and data by interacting directly with bulk storage 113. Furthermore, bulk storage may be alternatively provided by a network-attached storage device (not shown), which is accessed through a network interface 115.

A user may enter commands and information into the computer system 100 through the network interface 115 or through an input device 127 such as a keyboard, a pointing device commonly referred to as a mouse, a trackball, a touch pad tablet, a controller, an electronic digitizer, a microphone, an audio input interface, or a video input interface. Other input devices may include a joystick, game pad, satellite dish, scanner, and so forth. These and other input devices are often connected to CPU 102 through an input interface 118 that is coupled to the system bus, but may be connected by other interface and bus structures, such as a parallel port a game port or a universal serial bus (USB). A display 126 or other type of video device may also be connected to the system bus 122 via an interface, such as a graphics controller 116 and a video interface 117. In addition, an output device 128, such as headphones, speakers, or a printer, may be connected to the system bus 122 through an output interface 119 or the like.

The computer system 100 may operate in a networked environment using a network 123 to one or more remote computers, such as a remote computer 125. The remote computer 125 may be a terminal, a personal computer, a server, a router, a network PC, a peer device or other common network node, and typically includes many or all of the elements described above relative to the computer system 100. The network 123 depicted in FIG. 1 may include a local area network (LAN), a wide area network (WAN), or other type of network. Such networking environments are commonplace in offices, enterprise-wide computer networks, intranets and the Internet. In a networked environment, executable code and application programs may be stored in the remote computer. By way of example, and not limitation, FIG. 1 illustrates remote executable code 124 as residing on remote computer 125. It will be appreciated that the network connections shown are exemplary and other means of establishing a communications link between the computers may be used.

Collectively, these elements are intended to represent a broad category of computer systems, including but not limited to general purpose computer systems based on one or more members of the family of CPUs manufactured by Intel Corporation of Santa Clara, Calif., the family of CPUs manufactured by Advanced Micro Devices (AMD), Inc., of Sunnyvale, Calif., or the family of ARM CPUs, originally designed by Advanced RISC Machines, Ltd., as well as any other suitable processor. Of course, other implementations are possible. For example, the server functionalities described herein may be implemented by a plurality of server sub-systems communicating over a backplane.

Various components of computer system 100 may be rearranged, deleted, or augmented. For example, system bus 122 may be implemented as a plurality of buses interconnecting various subsystems of the computer system. Furthermore, computer system 100 may contain additional signal busses or interconnections between existing components, such as by adding a direct memory access unit (not shown) to allow one or more components to more efficiently access system memory 108.

As shown, CACHE1 and CPU1 are packed together as “processor module” 102 with processor CPU1 referred to as the “processor core.” Alternatively, cache memories 101, 103, contained in 102, 104 may be separate components on the system bus. Furthermore, certain embodiments of the present invention may not require nor include all of the above components. For example, some embodiments may include a smaller number of CPUs, a smaller number of network ports, a smaller number of storage devices, or a smaller number of input-output interfaces. Furthermore, computer system 100 may include additional components, such as one or more additional central processing units, such as 104, storage devices, memories, or interfaces. In addition, one or more components of computer system 100 may be combined into a specialized system-on-a-chip (SOC) to further system integration. In some computer system environments where component count is critical, the entire computer system may be integrated in one or more very large scale integrated (VLSI) circuit(s).

As discussed below, in one implementation, operations of one or more of the physical server or client systems described herein is implemented as a series of software routines executed by computer system 100. Each of the software routines comprises a plurality or series of machine instructions to be executed by one or more components in the computer system, such as CPU 102. Initially, the series of instructions may be stored on a storage device, such as bulk storage 113. However, the series of instructions may be stored in an EEPROM, a flash device, or a DVD. Furthermore, the series of instructions need not be stored locally, and could be received from a remote computer 125 or a server on a network, via network interface 115.

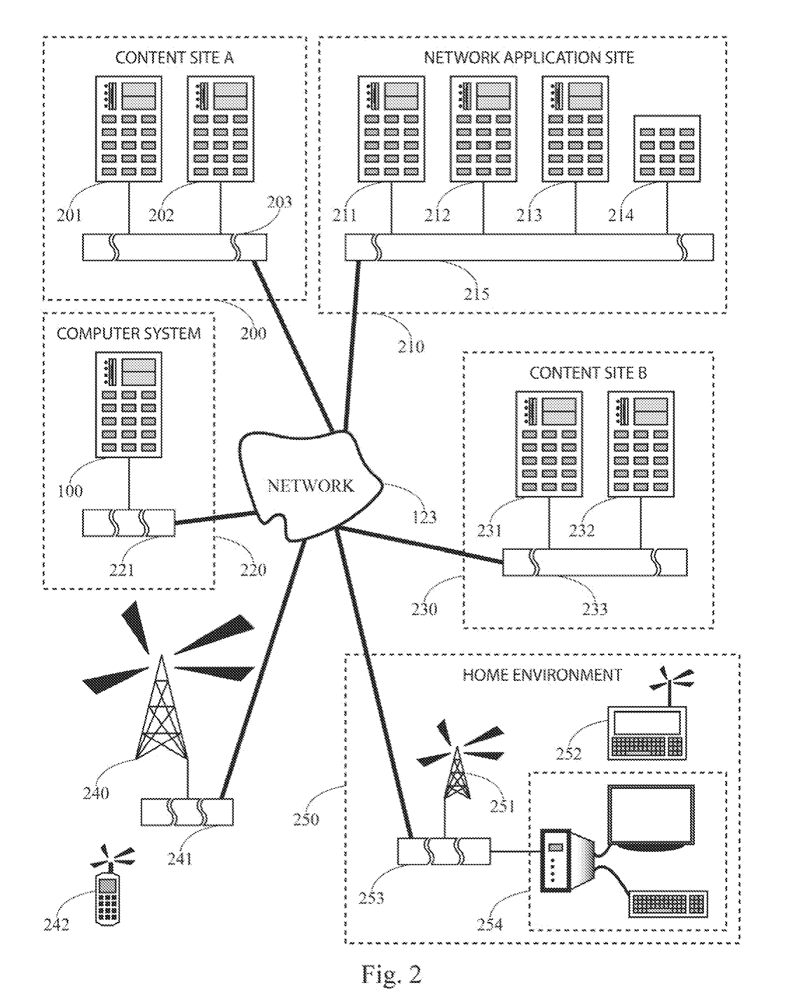

FIG. 2 illustrates computer system 100 placed in an example wide area network environment, such as the Internet. Network cloud 123 generally represents one or more interconnected networks, connecting computer system 100, a plurality of network sites, 200, 210, 220, 230, 240, and 250, and a plurality of client devices, 242, 251, 252, and 254. Network cloud 123 may include TCP/IP based wide area networks, private networks, wireless networks, satellite networks, cellular networks, paging networks, and the like. Client systems, such as portable device 242, portable computer 252, and personal computer 254 are operably connected to the wide area network environment through an internet service provider (not shown), a cellular provider 240, a wireless provider (not shown), a local wireless network 251, and/or a local wired network 253.

Computer system 100 is contained within the network site 220, where one or more computer systems, such as computer system 100, are connected to a local area network and router 221. The router 221 manages local computer communication traffic in network site 220 and interconnects with network cloud 123. Router 221 also functions to translate one or more local area network addresses in network site 220 to provide one or more unique corresponding wide area network addresses in order to facilitate communication between computer systems in network site 220 and other computer systems on the wide area network.

FIG. 2 illustrates a number of network service provider sites, including content site A 200, content site B 230, and network application site 210. The described invention may operate with one or more content providing or application sites. Although FIG. 2 illustrates the provider sites as separate local network sites, the functionality of each site may be combined with other sites. Further, a function for a particular site may be performed in a distributed computing environment by one or more computer systems at remote sites. Further still, the functionality represented by each depicted site may be further separated into a plurality of sub-function sites. In addition, implementations of the invention may operate in network environments that include multiples of one or more of the individual sites or subsystems of sites described herein. Implementations of the invention may also operate in network environments where one of more of the systems or sites described herein has been eliminated.

Content aggregation sites are represented by content site A 200 and content site B 230 in FIG. 2. Content is stored as one or more digital data objects. A digital data object may include one or more media objects or executable code objects. Content site A 200 is a network addressable system that allows users to access media objects supplied by one or more users. In one implementation, content site A 200 may be a media object aggregation or sharing system, such as Yahoo! Flickr® photo sharing site, and similar variants. Content site A 200 comprises one or more physical server systems 201, 202, implemented using an architecture such as that of computer system 100, and containing or connected to one or more bulk storage systems, such as that of bulk storage system 113, or a network attached storage device (not shown), and a local area network and router 203. The one or more physical servers allow users to upload and download media objects. In one implementation, the functionality hosted by the one or more physical servers may include web or HTTP servers, FTP servers, and the like.

Content site B 230 is a network addressable system that allows users to access content supplied by one of more content suppliers (not shown). Content site B 230 comprises one or more physical server systems 231, 232 containing or connected to one or more bulk storage systems (not shown), and a local area network and router 233. The one or more physical servers 231, 232 allow the service provider (not shown) to store media objects and users to download media objects.

Network application site B 210 is a network addressable system that allows users to access one or more executable code objects supplied by one or more service providers (not shown). Network application site B 210 comprises one or more physical server systems 211, 212, 213 containing or connected to one or more bulk storage systems, shown as network-attached storage device 214, and a local area network and router 215. Executable code objects may include code to be executed on a client device as well as code executed within a server system, such as server 212. An example of an executable code object is an informational web site where users request and receive identified web pages and other content over the network cloud 123. The executable code object may also be a posting forum, where users may submit or otherwise configure media objects to be perceived by other users. The executable code object may also be a social network application, such as a chat client or e-mail client, adapted to establish intermediated or peer-to-peer communication with other clients. The executable code object may also be a web-posting application, allowing users to configure and maintain personal web pages. One or more executable code objects may also combine to form a content distribution application that displays available media objects and transmits them to users. Examples of network application sites include Yahoo! Music Engine®, Apple iTunes®, and podcasting servers.

In media object aggregation or sharing systems, such as the Yahoo! Flickr® photo sharing site, media objects are typically contained in data objects which also contain metadata related to the media object. For example, a data object containing a media object may also contain one or more meta keywords or tags to identify related media objects. A photo sharer may upload a photo to a photo sharing site, and consider the photo related to a set of keywords, such as “artists,” “musicians,” “drummers,” and “teen-idols.” The photo sharer may further configure the media object by combining the media object with the set of related meta parameters in a data object.

In the context, of a computer network, a “virtual server” is physically one or more server systems connected to the network and support circuitry to execute application programs which process data. Data may be stored by means which facilitate efficient processing, such as by storing the data in a “database” consisting of a collection of data organized by relationships between the various forms of data contained therein. When a virtual server consists of more than one computer server system, the set of computer server systems is interconnected hierarchically to perform high-level functions as combined functions of several servers under central control.

Functionally, a virtual server executes a sequence of low-level CPU commands to complete instructions for processing data. A virtual server typically accepts instructions and executes commands for a multitude of “clients”. The instructions may include, but are not limited to, instructions to store or retrieve data, to modify, verify or erase data, or to reorganize data. A virtual server may also initiate instructions for other network-attached devices. For example, a virtual “music server” might maintain a database to locate a library of musical compositions. The music server might receive commands to store new songs or retrieve old ones from a number of clients. Further, the music server might send commands to other devices on the network, e.g., to disseminate the musical database among various subservient servers, such as a “jazz server,” a “hip-hop server,” a “classical server,” and so on, to register paying user requests in a “billing server” to verify the identity, preferences, and access privileges of a user in a “registration server” and so on. The music server may therefore also be a client of other servers. Practitioners of the art will recognize that virtual servers and clients are abstract interactive devices controlled by software instructions, whose interaction protocols may be flexibly defined. A “client” as used herein may include functionally to process information and programs, as well as to issue commands. Similarly, a virtual server as used herein may include functionally to initiate commands to users and other servers as well as to respond to instructions.

Similarly, a database should not be construed to be a single physical collection of data. As used herein, a database is an abstract collection of data which may be distributed over one or more physical locations. Said data may be stored physically within a single or multiple servers, within attached physical device(s), network attached device(s), or user devices(s). Similarly, an application program should not be construed to be a single physical collection of commands. As used herein, an application program is an abstract collection of CPU commands, which may be physically executed, in whole or in part, within a single or multiple servers, within attached physical devices(s), within network attached device(s), or within user device(s).

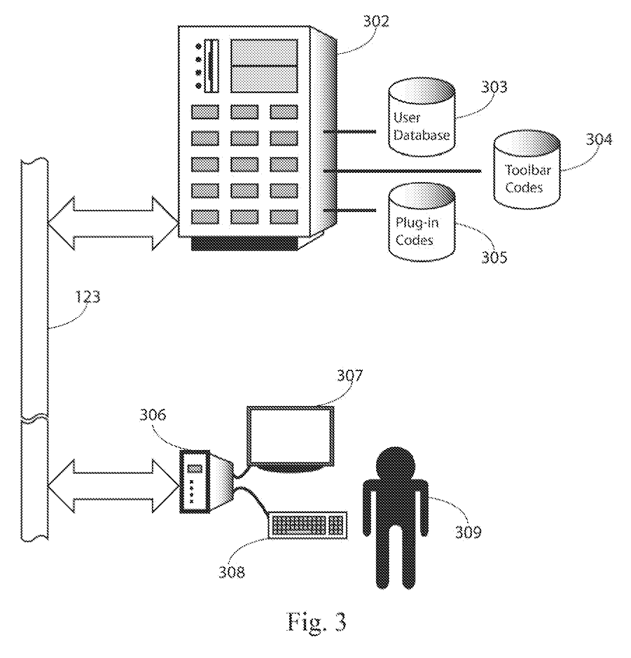

FIG. 3 illustrates a client-server system, where a software provider interacts with a plurality of users. User 309 is able to communicate over the network 123 through the use of a network client application, such as a web browser. User 309 typically has a network access device 306, such as a computer, a text input device 308, such as a keyboard, and observes a two-dimensional display 307, such as a monitor. The software provider operates a virtual registration server 302 over the network 123 which maintains a registration website (not shown), a database of user identities 303 and a database of computer software code 304 to enable network users to access an enhancement service. Server 302 is operative to register new users and to supply appropriate software code.

Server 302 implements a registration process which may include one or more of (1) determining whether the user is a new or a returning user, (2) authenticating the returning users, (3) storing a set of user attributes, (4) accessing a set of user attributes, (5) and enabling use of the enhancement service by providing one or more software codes.

In FIG. 3, the software codes, contained in database 304, consist primarily of plug-in code modules for various browsers and/or operating systems. The software code may additionally include one or more plug-in code installers. A code installer is operative to install a plug-in operating within the context of a general-purpose web browser. The plug-in is operative to functionally replace, augment, or modify the web browser functionality. Further, a code installer may include code to install a toolbar application, as described below, for one or more browsers, or to modify an existing toolbar application to include the plug-in module in the toolbar display.

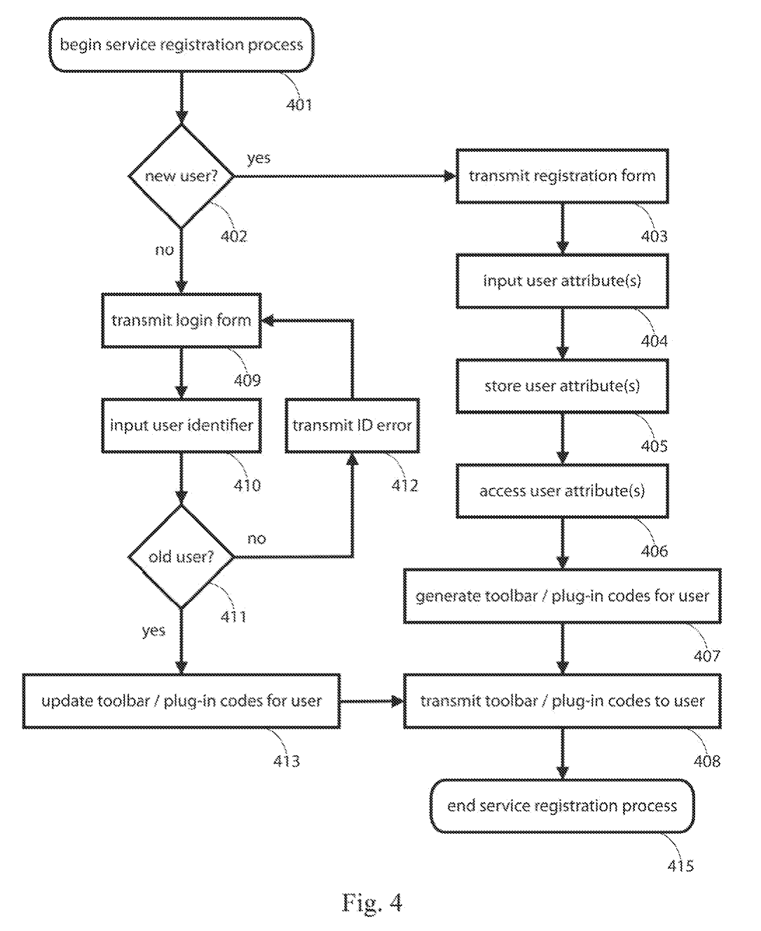

FIG. 4 is a flowchart representing an example service registration process consisting of a number of software steps. Components in a service-provider's registration server 302 execute computer-readable instructions to implement the software steps. The registration process scans user input to determine whether a user accessing the server is a new user in step 402. For new users, the registration process scans entries on an online registration form, transmitted in step 403, to input, in step 404, and store, in step 405, one or more user attributes including a unique user identifier (ID) in the user database 303. Optionally, the registration server executes commands to incorporate user privileges and/or preferences in the stored user attributes.

For new users, the output of the service registration process is operative to provide a media enhancement mechanism for the user's preferred browser. The user may prefer to augment or modify the functionality of the existing browser application by accessing the plug-in using the existing browser pull-clown menus. Further, the user may install or modify an existing toolbar application to access the plug-in using the toolbar menu, as explained below.

The software codes are operative to facilitate the browser enhancement mechanism. The enhancement mechanism locates one or more media objects related to text or existing media objects on a web page. The software codes may further facilitate the browser-enhancement mechanism by starting a media object player application. Once installed on a client device, the user invokes the enhancement mechanism by clicking on the toolbar application icon or selecting a plug-in menu item. In step 407, registration server 302 retrieves, and in some instances, dynamically generates a set of appropriate toolbar modifiers and/or plug-in codes for the user, and transmits the codes to a user device 306 in step 408. For dynamically generated code, the server may dynamically add one or more user attributes, such as a user identifier, to the code. The user attributes may relate to one or more parameters pertinent to the operation of the enhancement mechanism. For example, the user attributes may include parameters that bias or control selection of photographic media objects over video/audio media objects. These parameters can be used to further bias the selection of media, as described below, to allow for composer or consumer personalization.

After the software has been installed, the user may activate the registration process as a returning user. The registration process authenticates returning users by scanning input, in step 410, to an online login form, transmitted in step 409, to determine if the login ID resides in the user database 303 in step 411. The user may optionally be further identified by use of a password or other authentication method. If the scanned user input information does not correspond to a user database entry, an error message is transmitted in step 412, and the user may re-enter login information in steps 409, 410.

When a returning user has been properly identified, their enhancement software codes are updated in step 413, and the updated codes are transmitted to a user device 306 in step 408.

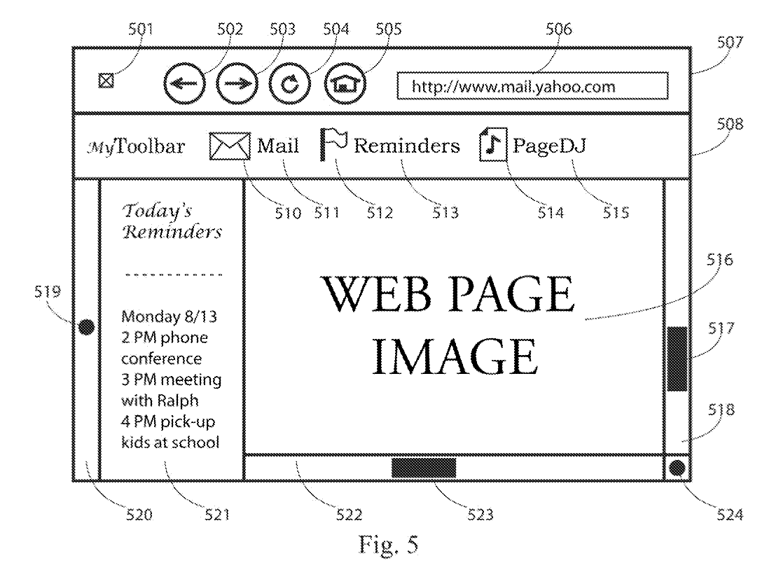

In FIG. 5, an example browser user interface window is illustrated. A computer user observes the interface when accessing a web page. Various user interface controls for the browser are depicted in a browser control bar 507. The user is able to delete the window using close button 501, to return to a preceding web page using back button 502, to return to a succeeding web page using forward button 503, to re-render the current page using refresh button 504, or to return to the user's preferred starting page using home button 505. The user activates a button by moving a pointer using a mouse or other pointing device and clicking the device button when the pointer is on top of the button image. Alternately, the user may navigate among web pages by typing in a network uniform resource locater (URL) in text window 506. When the URL is entered, the browser renders an image corresponding to the data file at the URL.

An initial image for the data file is rendered in a large rectangular page imaging area 516. The web page may have additional controls to scroll or otherwise navigate to a different visible area of the page. In FIG. 5, scrollbar 518 and slider 517 indicate the current position of the visible portion of the page relative to the top and bottom edges of the page. By pointing to, clicking on, and dragging slider 517 up or down, the user may navigate up or down and view a different portion of the page. Similarly, scrollbar 522 and slider 523 indicate the current position of the visible portion of the page relative to the left aid right edges of the page, and allow the user to navigate left or right and view a different portion of the page. The browser may additionally contains a resizing button, 524, allowing the user to click and drag the button to change the size of the browser window.

The browser interface in FIG. 5 also contains a customizable toolbar 508, labeled “MyToolbar.” The user is able to quickly access one of a designated set of one or more favorite applications within the browser environment. Icons or labels are used to represent the applications. In this example, the user has selected a mail client application, a scheduling application, and the “PageDJ” application of the current invention, to add to the toolbar. The mail application is associated with an icon 510, a label “Mail” 511, or both, as shown. The user may access the mail application by clicking on tire associated icon 510 and/or label 511. The scheduling application is associated with an icon 512, a label “Reminders” 513, or both, as shown. The “PageDJ” application is associated with an icon 514, a label “PageDJ” 515, or both,

An example sidebar application is shown as a displayed text window 521, as might be invoked by the user clicking on the “Reminders” label 513. An adjustable portion of the browser window is dedicated to the sidebar application. The user is able to change the portion of the browser window dedicated to the browser application using slider 519 to adjust drawer bar 520. When the user points to slider 519 and clicks, the user is able to drag the separation bar left/right to increase/decrease the sidebar application's portion of the browser window, as though the drawer slides behind the rest of the window.

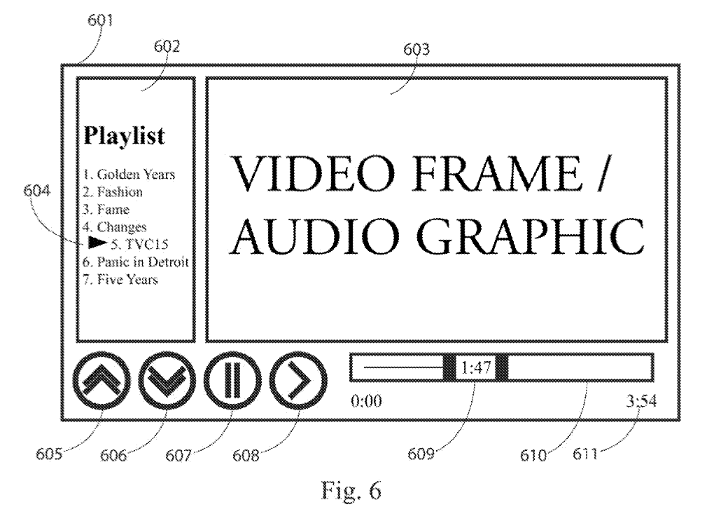

In FIG. 6, an example playlist player user interlace is illustrated. A playlist is a list of media objects to be rendered or “played.” An example playlist is shown in text window 602. In this example, a user accessed a web page related to the recording artist David Bowie, and invoked the enhancement mechanism. In response, the browser renders or updates the display of the playlist player by, for example, generating a list of titles of seven accessible media objects consisting of music or music/videos performed by David Bowie. A current selection marker 604 indicates which of the media objects (entitled “TVC15” in this example) is currently being accessed. A video image for the currently accessed media object is rendered within rectangular display area 603, which shows, for example, a video stream of frames or one or more still graphics associated with the media object as it plays. The currently accessed media object may also generate an audio stream, routed to an audio output of the computer and perceived through one or more user audio transducers, such as a pair of headphones or speakers (not shown). Example user interface controls are shown along the bottom of FIG. 6. Up button 605 is used to return to a lower numbered selection in the playlist, while down button 606 is used to fast-forward to a higher numbered selection in the playlist. Pause button 607 freezes rendering of the media object and mutes the audio output. Rendering and audio are resumed using play button 608.

In this example, the browser is playing a music video that is three minutes and 54 seconds long, as shown by duration indicator 611. Time-line display 610 shows the relative portion of the music video played so far. Time slider 609 redundantly indicates that so far, one minute and 47 seconds of the video has played. By pointing to, clicking on, and dragging the time slider, the user may skip ahead in the video dragging right or return to an earlier portion of the video dragging left. The combination of controls allows the user to efficiently manage and render albums of media objects. In one implementation, the playlist player is rendered in a separate pop-up window by the browser as shown. When the playlist player is rendered in a separate pop-up window, the player includes a close box 612 to allow the user to dismiss the player.

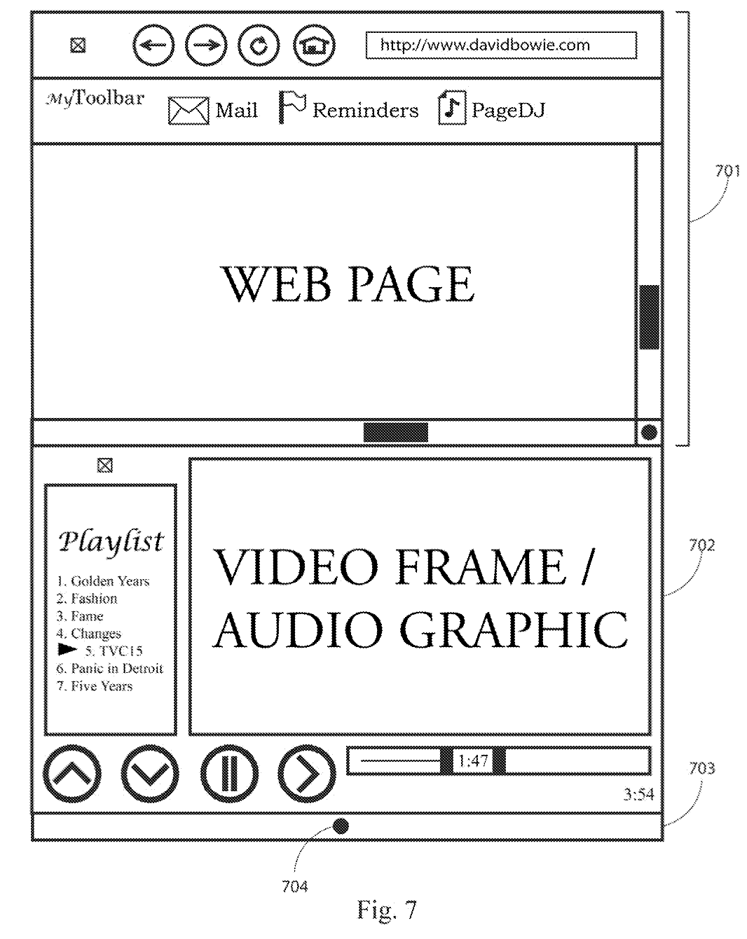

In an alternate implementation, the playlist player is installed as a sidebar application in the browser window. This is illustrated with an example sidebar application interlace included as shown in FIG. 7. The upper half of the browser window 701 is similar to that shown in FIG. 5. The upper half contains a browser interface with a close button, various navigational buttons, and a text URL entry area, a user customizable toolbar menu area, a web page display area, and scrolling mechanisms. A user invoking the “PageDJ” application generates the sidebar application shown as the bottom half of the browser window and including 702-704. The playlist player interface of FIG. 6 is incorporated in the browser window as rectangular area 702. Slider 704 and drawer bar 703 allow the user to change the portion of the browser window dedicated to the playlist player by dragging slider 704 up or down.

When a consumer accesses the enhancement mechanism through the toolbar or a plug-in, script functions can interact with the Document Object Model (DOM) of the web page to perform one or more tasks. Scripts may also be used to make service requests to remote servers after an HTML page has loaded. These requests can obtain new information or data, as well as load or launch additional applications, e.g., media object players, content viewers, playlist players, application plug-ins, or software codes. Script code can merge with the DOM of the underlying page so that one or more additional media objects are displayed or otherwise rendered on the page. Alternatively, the script code may initiate one or more additional pages or other rendering for the additional media object(s). When embed code is inserted into an HTML document and subsequently accessed by a client application, the client application may retrieve and execute the script. The script, optionally using the parameter values in the embed code, may initiate service requests to one or more remote servers to retrieve and render one or more media objects that enhance the underlying content of the page. For example, the script, when executed, may cause the client application to query playlist server 801 and/or media server 807, described below, to retrieve one or more media objects, and then cause a client application to render the retrieved media object(s).

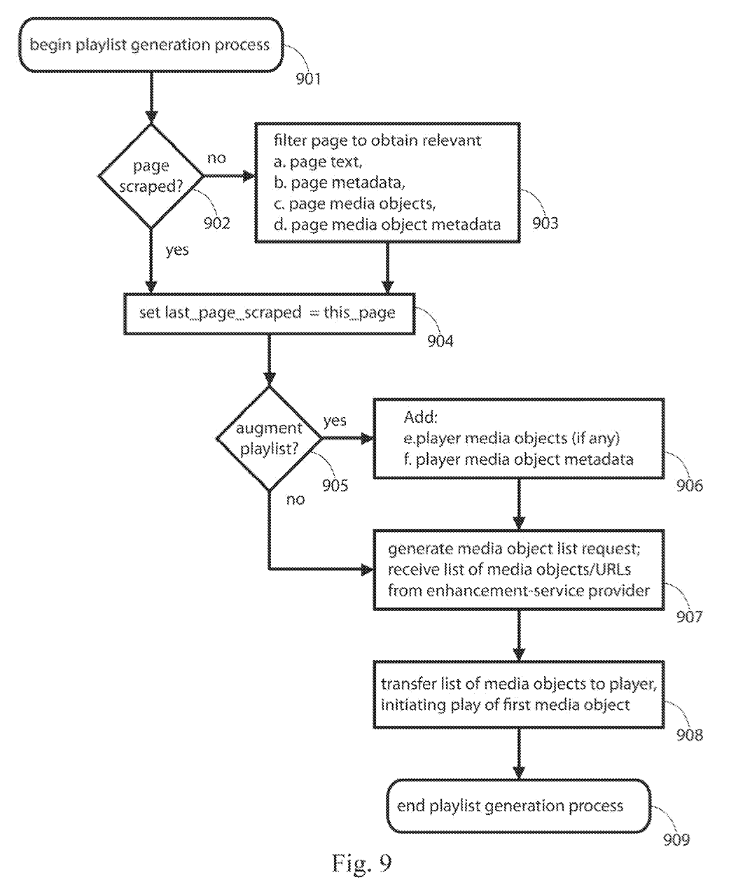

In addition, the script may access the DOM of the underlying HTML page to extract and process information. For example, as FIG. 9 illustrates, the script may process the data of the underlying HTML page to extract media objects and related text of the page in order to form retrieval requests. The script could also perform additional operations. For example, the script could process the data of the HTML page, filtering out extraneous information such as “the”, “a”, “and”, and the like, and transmit only the relevant media selection information when querying for media objects for page enhancement. In addition, the script may access the DOM to identify the server (identified, in one possible implementation, by uniform resource locater) that hosts the underlying HTML page.

Another way to detect underlying or theme information of a data object is to read the metadata in the data object in an automated way. In an alternative implementation, the script may extract one or more meta parameters that may be useful, for example, to select one or more media objects. For example, a photographic media object may include additional information about the photograph in one or more “meta tags” in the metadata. An example meta tag includes <meta name=“keywords” content=“photography, digital photography, camera phones, camera”>. A mechanism for automatically retrieving information in the data object is known as a page-scraping mechanism. The page-scraping mechanism retrieves text in metadata as well as user-composed text. Retrieved text is used to determine a page theme using technology for determining semantic meaning. Metadata as provided by the user or a media object supplier would be valuable to understand the theme of the data object. Using this information and the text content of the page, a semantic engine may select one or more relevant topics from a dictionary, and may select one or more relevant media objects to enhance the page.

In addition, the enhancement mechanisms disclosed may employ a categorization tool to characterize data object text or metadata. Categories can be associated with one or more keywords. For example, a meta tag containing “photography” and text describing the Grand Canyon may be characterized as a category of photographs that came from Arizona and may be associated with a keyword entitled “ArizonaPics,” As another example, a user sharing a media object representing a photograph of the performing artist Sheila E might associate the media object with a keyword entitled “Prince,” the name of another performing artist who often employs Sheila E.

In addition, the enhancement mechanisms disclosed may employ mechanisms for consumer personalization. When a network information consumer accesses a data object using a browser, for example, script code may access consumer identifiers in a consumer “cookie” or some other consumer data file. The cookie or data file is a data object containing one or more meta parameters specific to the consumer. By accessing the consumer's meta parameters, an embed code may optionally include instructions to bias the selection of media to include consumer preferences and/or consumer access privileges in a service request.

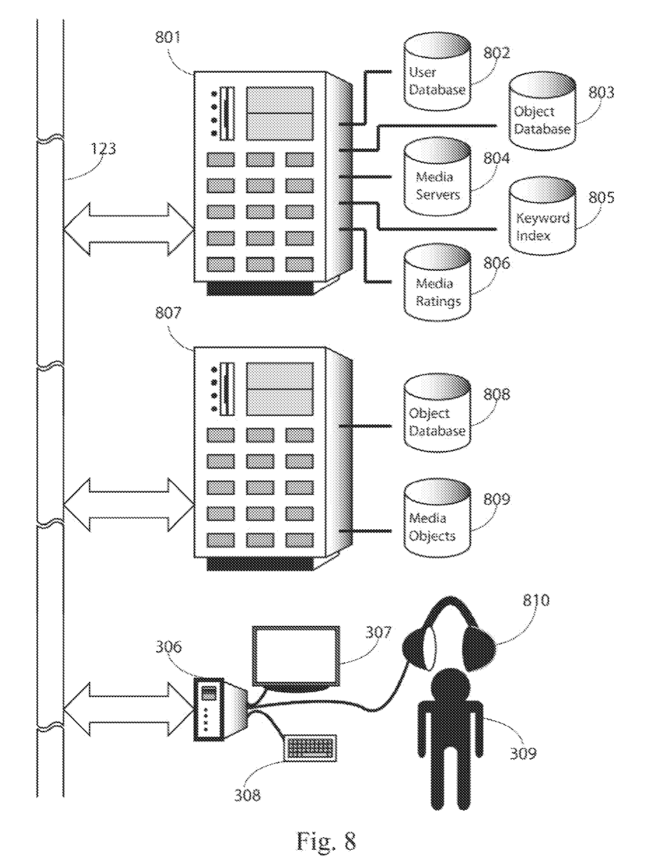

Referring to FIG. 8, a computer user 309 on network 123 is able to access a playlist server 801 and media object server 807. Computer user 309 has a pair of headphones 810 to listen to the computer's audio output. When, computer user 309 operates a browser application and invokes the enhancement mechanism, the script functions interact with the currently observed web page and media object player to generate a request to playlist server 801 for a playlist of media objects. A media object in the playlist may be obtained from the enhancement server 801 or from another media server, such as media sewer 807.

Enhancement server 801 maintains one or more databases to facilitate the location of media objects accessible on the network. Example databases include a database of user metadata 802, a database of media object metadata 803, a database of media object server metadata 804, a database of index keywords 805, and a database to bias the selection of media objects 806.

User database 802 contains a collection of records of user identity and optionally, corresponding descriptive user parameters, such as geographic location and subscription status. Media object database 503 is a collection of records of currently accessible media objects. Media server database 804 is a collection of records describing media object supplying servers. Keyword index database 805 is a collection of records of one or more characterizing tags or attributes that may be associated with a media object. Media ratings database 806 is a collection of records that rate a media object relative to one or more associated attributes, such as popularity among media object consumers.

In FIG. 8, media server 807 accesses a number of example databases, 808-809. Object database 808 is a collection of records describing media objects provided by the media server. The records include one or more descriptions of media object attributes, such as the media type, a preferred media object player for the media object, date of creation, the physical location of the media object, and the like. Media object database 809 contains a collection of files corresponding to the media objects in a format suitable for communication over the network.

In one embodiment of the invention, the user has an ability to influence the selection of additional media objects by indicating a number of user preferences. In one alternative, the user preferences are designated in a separate preference menu (not shown). In another alternative, the user is able to adjust selection preferences with each request for an additional media object. The preferences may be grouped into categories, such as preferred media object type (e.g. video, audio, pictures, and the like), preferred attributes of additional media objects (e.g. media objects related to the chat conversation by artist or group, by genre, by mood, and/or by era, and the like), and other miscellaneous attributes, such as restrictions to media objects which can be found on the network, which can be found on the user's device, objects which can only be viewed with a subscription fee, objects which may be viewed freely, or media objects related to previously found media, objects, and so on.

As stated above, the additional media objects are related to the web page or previously played media objects. The additional media objects may be selected by processing the web page as a whole, or by processing a subset of the web page. In one embodiment, the user may further indicate which portions of the web page should be considered relevant to the additional media object selection process. For example, the user may drag the user cursor through a portion of text using a pointing device, to indicate that these phrases should be considered most relevant to the selection of additional media objects. As indicated below, selection of relative relevancy may also be embodied in an automated selection process. An automated process might provide (a) media objects related only to the original page, or (b) the original page and all previously located media objects for that page, or, alternatively, (c) the original page and the most recently located media objects for that page.

As mentioned above, the enhancement mechanisms rely on background server processes to find and transmit additional media objects. The background processes rely on the interaction of a number of interacting processes described briefly as follows. FIG. 9 is an example flowchart for a browser plug-in application in generating a playlist of media objects related to a current web page.

Referring to FIG. 9, the application begins by determining whether the web page has already been scraped to determine relevant text, media objects, and metadata in step 902. If not, the web page is scanned to extract text, media object identifiers, and metadata in step 903. The extracted information is optionally filtered as described above and ranked for initial relevancy. When the page has been scraped, the information is retained in a playlist selection data structure, and a playlist selection data structure field, last_page_scraped, is set to the URL of the page in step 904.

In step 905, the application checks to see if there is a previously generated playlist for the web page. If so, the media objects and associated metadata for the previously generated playlist are added to the playlist selection data structure in step 906. By adding the previously listed media objects to an additional media object list request, the application ensures that the same media objects will not be listed again.

The additional media objects are requested in step 907 and transmitted to the enhancement server 801. The application receives the playlist and transfers it to the player. The player receives titles of media objects and their network locations. The list of media object titles is displayed in the media object player 601, as in example list 604. The first media object is requested from a media object server, such as 807. The data object is received and decompressed. The visual stream for the first media object (if any) is rendered in the media object player 601 in rectangular area 603, and the audio stream (if any) is perceived through an audio transducer, such as 810, connected to the user's computer.

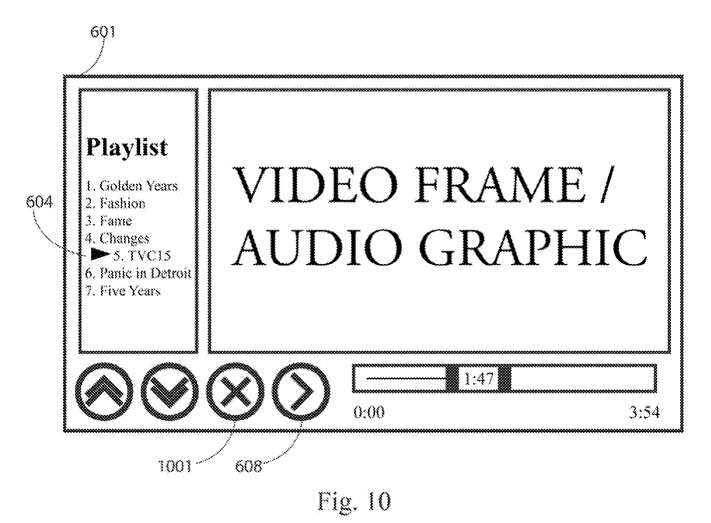

A feature of the invention, in one implementation, is the ability to modify the generated playlist. As shown in FIG. 6, a user to able to skip a selection in the playlist using a down button 606 or stop the playing of a selection using the pause button 607. A user activating the pause button may dislike the current selection, and desire to remove it from the playlist. A means of facilitating this removal is shown in FIG. 10. After the user activates pause button 607, the button is replaced with remove button 1001. If the user further activates remove button 1001, the selection is removed from the list. In the example of FIG. 10, the paused, song “TVC15” is deleted from the list if the remove button is activated. In another embodiment, the remove mechanism is displayed as a separate, dedicated remove button, while in another embodiment, the remove mechanism is implemented through edit menu “cut” commands.

Another feature of the invention, in one implementation, is the ability to generate a continuous selection of additional media objects. In an example auto-generate mode, the user is able to set a player preference to generate a new playlist request whenever a current playlist is exhausted. As shown in FIG. 9, the player may invoke the playlist generation process with a previously scraped page and an existing playlist. In this case, the playlist generation process augments the previous media object request with the existing playlist. The enhancement server 801 provides a list of additional media objects not previously listed, desirably ensuring fresh selections in the new playlist. A typical user may easily invoke the player from a preferred starting web-page theme, and allow the player to auto-generate a program consisting of a plurality of playlists related to the theme.

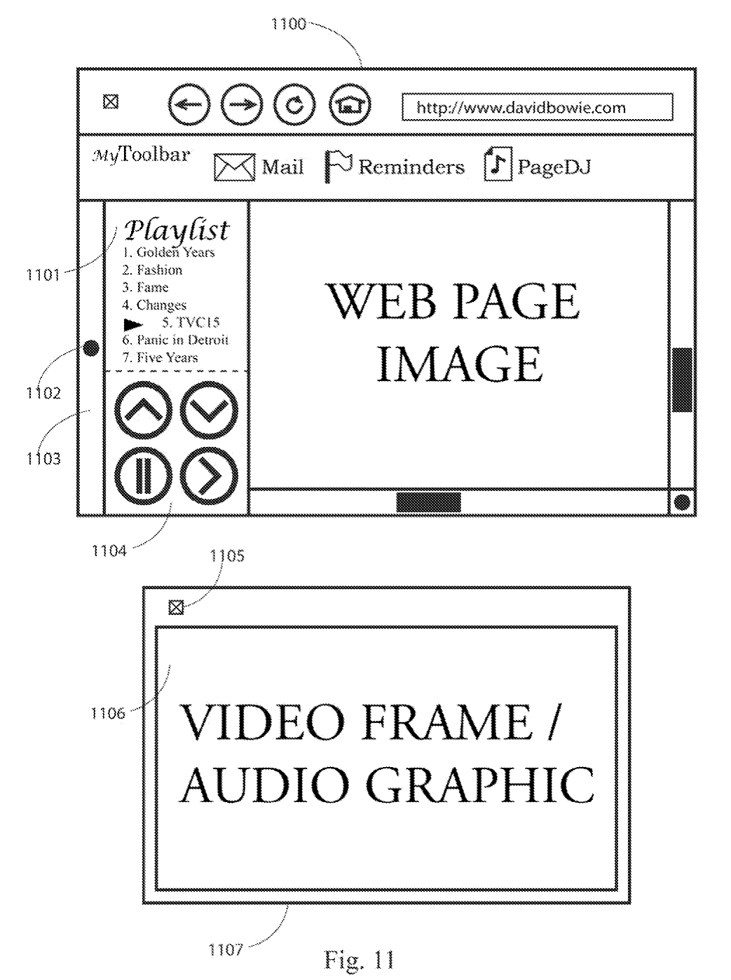

As those skilled in the art may appreciate, various controls of the toolbar application and playlist player may be resized, rearranged, recombined, or differently represented without departing from the true spirit of the invention. In one alternative, the play and pause controls of the playlist player, for example, are displayed as part of the toolbar. In other alternatives, pause/play controls for the playlist player and up/down controls for the selection in the playlist are combined with a textual rendering of the playlist in a pop-up window, or in a sidebar window as illustrated in FIG. 11.

In this user interface of FIG. 11, the user has initiated the player by engaging the “PageDJ” icon or label in the toolbar, or by accessing the “PageDJ” in a pull-down browser toolbar menu. In response, the toolbar application requests and receives a playlist of media objects related to the current web page.

The interface is illustrated as an example sidebar window 1101-1104. The playlist is displayed as a numbered text list of titles in a playlist display area 1101, as shown previously in text window 602. In another interface implementation, the sidebar interface of FIG. 11 is displayed in a pop-up window instead of a sidebar. A marker shows the currently accessed media object in the playlist. The (up, down) controls for traversing the playlist, as well as the (play, pause/remove) controls for the playlist player are also displayed a player control area 1104 in the sidebar application window.

The sidebar window interface of FIG. 11 is particularly suitable for audio media objects without accompanying graphics, where only the main window with the sidebar interface 1100 is displayed. The user finds all the main toolbar application controls in one central location with the playlist. In one embodiment, the sidebar application is implemented in a opening/closing drawer as illustrated in FIG. 11. When the application is invoked, the drawer opens and displays the playlist and controls. A user wishing to minimize the user interface may engage slider button 1102 in drawer slider 1103 to partially or completely close the sidebar window. In one implementation, the sidebar application continues to operate in the background. The sidebar application may also have other controls such as a close box (not shown) to stop execution of the sidebar application, or a minimize box (not shown) to hide the sidebar application window.

The sidebar interface of FIG. 11 is also suitable for media objects with a video stream or video graphics when combined with a separate window 1105 where the media object's video stream is displayed. The separate video stream window interface has several advantages, in that the window is easily resized to accommodate different video image 1106 dimensions, and distracting controls on the video stream interface are desirably minimized. In this example, the only interface control on video stream window 1107 is a means to hide or minimize the window, as for example, with close box 1105.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A method comprising
responsive to user action invoking a toolbar application operably associated with a network browser application,
accessing one or more attributes of a web page currently accessed by the network browser application;
interacting with one or more remote systems to receive an ordered playlist identifying one or more media objects based on the one or more attributes; and
invoking a media object player to cause the media object player to access and play, during a browsing session, the one or more media objects identified in the ordered playlist.

2. The method of claim 1, further comprising
interacting with the browser application to display the playlist and one or more controls to enable the user to traverse the playlist;
interacting with the browser application to display a media object player and one or more controls to enable the user to interact with the media object player; and
operably responding to the media object player controls and playlist traversing controls to render the one or more media objects in the order specified in the playlist.

3. The method of claim 1, wherein the one or more web page attributes include one or more of phrases of text in the web page, metadata associated with the web page, an identification of one or more media objects included in the web page, or metadata associated with the one or more media objects included in the web page.

4. The method of claim 1, wherein the interacting with one or more remote systems includes identifying one or more user attributes, indicating one or more of a user identifier, a set of one or more preferences for the user, a set of one or more access privileges for the user, a geographic locator for the user, an age of the user, and a set of media object players accessible to the user; and wherein the associating of one or more media objects is biased by the one or more user attributes.

5. The method of claim 1, wherein the user action comprises pointing to and clicking on a browser toolbar icon or label.

6. The method of claim 1, wherein the user action comprises selecting a browser pull-down toolbar menu, and selecting a menu item with the name of the tool.

7. The method of claim 2, wherein the playlist is displayed in a sidebar window attached to a main browser window, or is displayed in a pop-up window separated from a main browser window, and is displayed with one or more controls to traverse the playlist.

8. The method of claim 2, wherein the playlist traversing control includes one or more of an “up” control to select a lower numbered item in the playlist, a “down” control to select a higher numbered item in the playlist and a “remove” control to delete an item from the playlist.

9. The method of claim 1, wherein a video stream for the media object is rendered in a sidebar window attached to a main browser window, or is displayed in a pop-up window separated from a main browser window.

10. The method of claim 2, wherein the media object player controls include one or more of a “pause” control to mute a currently playing audio stream associated with a media object and to freeze a currently playing video stream, if any, and a “play” control to resume rendering of a video stream (if any) and decoding of an audio stream for the media object.

11. A computer readable medium for installation of a tool in a browser toolbar, said tool operative to respond to a user action to invoke the tool in the browser application by:
accessing one or more attributes of a web page currently accessed by the network browser application;
interacting with one or more remote systems to receive an ordered playlist identifying one or more media objects based on the one or more attributes; and
invoking a media object player to cause the media object player to access and play, during a browsing session, the one or more media objects identified in the ordered playlist.

12. The computer readable medium of claim 11, further operative to:
interact with the browser application to display the playlist and one or more controls to enable the user to traverse the playlist;
interact with the browser application to display a media object player and one or more controls to enable the user to interact with the media object player; and
respond to the media object player controls and playlist traversing controls to render the one or more media objects in the order specified in the playlist.

13. The computer readable medium of claim 11, wherein the one or more web page attributes include one or more of phrases of text in the web page, metadata associated with the web page, an identification of one or more media objects included in the web page, or metadata associated with the one or more media objects included in the web page.

14. The computer readable medium of claim 11, wherein the interacting with one or more remote systems includes identifying one or more user attributes, indicating one or more of a user identifier, a set of one or more preferences for the user, a set of one or more access privileges for the user, a geographic locater for the user, an age of the user, and a set of media object players accessible to the user; and wherein the associating of one or more media objects is biased by the one or more user attributes.

15. The computer readable medium of claim 11, wherein the action of the user comprises pointing to and clicking on a browser toolbar icon or label.

16. The computer readable medium of claim 11, wherein the action of the user comprises selecting a browser pull-down toolbar menu, and selecting a menu item with the name of the tool.

17. The computer readable medium of claim 12, wherein the playlist is displayed in a sidebar window attached to a main browser window, or is displayed in a pop-up window separated from a main browser window.

18. The computer readable medium of claim 12, wherein the playlist traversing control includes one or more of an “up” control to select a lower numbered item in the playlist, a “down” control to select a higher numbered item in the playlist, and a “remove” control to delete an item from the playlist.

19. The computer readable medium of claim 11, wherein a video stream for the media object is rendered in a sidebar window attached to a main browser window, or is displayed in a pop-up window separated from a main browser window.

20. The computer readable medium of claim 12, wherein the media object player controls include one or more of a “pause” control to mute a currently playing audio stream associated with a media object and to freeze a currently playing video stream, if any, and a “play” control to resume rendering of a video stream (if any) and decoding of an audio stream for the media object.

21. A method to generate a sequence of play lists related to a web page comprising
generating a first web page playlist for each newly accessed web page by
accessing one or more attributes of a first web page currently accessed by the network browser application;
interacting with one or more remote systems to receive an ordered playlist, identifying one or more media objects based on the one or more web page attributes; and
invoking a media object player to cause the media object player to access and play, during a browsing session, the one or more media objects identified in the ordered playlist; and
recursively generating a successor playlist of a current playlist, by
accessing the one or more current attributes previously used to generate the current playlist;
accessing metadata associated with the media objects in the current playlist;
combining the associated metadata with the one or more previously used attributes to form a superset of attributes;
interacting with one or more remote host systems to identify one or more media objects based on the superset of attributes in a successor ordered playlist.

22. The method of claim 21 where the identification of one or more media objects to associated with a set of attributes includes
determining one or more media objects identified as previously selected in the set of attributes; and
biasing the association of one or more media objects to reject media objects identified as previously selected.
